(19) United States
(12) Patent Application Publication
(10) Pub. No.: US 2017/0319885 A1
(43) Pub. Date: Nov. 9, 2017

(54) Heat-Sensitive Trigger for a Fire Sprinkler Valve

(71) Applicant: Bulb Link, LLC, Salt Lake City, UT (US)

(72) Inventor: Karl Walker, St. George, UT (US)

(73) Assignee: Bulb Link, LLC

(21) Appl. No.: 15/368,253

(22) Filed: Dec. 2, 2016

Related U.S. Application Data
(63) Continuation-in-part of application No. 15/148,640, filed on May 6, 2016, now Pat. No. 9,539,451.

(51) Int. Cl. A62C 37/12; A62C 35/68; B05B 1/26; B05B 1/32

(52) U.S. Cl. CPC A62C 37/12; B05B 1/32; A62C 35/68; B05B 1/265

(57) ABSTRACT

A fire sprinkler valve trigger has a body or tube segmented into opposite segments joined together at a joint by a fusible material with a predetermined and selected melting temperature less than a melting temperature of the opposite segments. An exterior of the body or tube comprises a layer added to the exterior, and comprising a preselected color corresponding to and designating the melting temperature of the fusible material. The body or tube, including the joint and the fusible material, being exposed and visible so that the layer on the exterior of the body or capsule is exposed and visible.

### PRIORITY CLAIM(S)

This is a continuation-in-part application of U.S. patent application Ser. No. 15/148,640, filed May 6, 2016, which is hereby incorporated herein by reference.

### BACKGROUND

### Field of the Invention

The present invention relates generally to fire suppression sprinklers. More particularly, the present invention relates to heat-sensitive trigger for a fire sprinkler valve or head.

### Related Art

Fire sprinkler valves are used in fire suppression systems for buildings or facilities. Such fire sprinkler valves have a plug retained by a heat sensitive trigger. Prior art fire sprinkler valves use triggers that arc generally of two types: 1) older mechanical linkage triggers; and 2) newer frangible bulb triggers. The older mechanical linkage triggers used an offset linkage or a spring loaded linkage held in place by an alloy that melts at a low temperature, releasing the linkage, and thus the plug. The newer frangible bulb triggers use a glass bulb filled with a liquid that expands when heated, bursting the glass bulb, and releasing the trigger. The trigger mechanism is usually held between a yoke or frame and the plug. For example, see U.S. Pat. No. 5,967,238 and U.S. Pat. No. 4,796,710. The glass bulbs, however, can sustain hairline fractures during shipping; resulting in leakage of the liquid. In addition, the liquid in the bulb can be colored to correspond to a head rating of the bulb, i.e. the heat at which the bulb bursts, activating the sprinkler. The color in the liquid, however, can fade in UV light and cold temperatures. Thus, the fire sprinkler valves with a bulb type trigger have a limited life expectancy of 25 years and should be inspected regularly. The older style fire sprinkler valves with a linkage type trigger have a life expectancy of 50 years.

### SUMMARY OF THE INVENTION

It has been recognized that it would be advantageous to develop a heat sensitive trigger for a fire sprinkler valve that can replace bulb-type triggers, that is more robust, less prone to color fading or loss of liquid, and has a rapid response time index (RTI) as good or better than bulb-type triggers, and a life expectancy of at least 50 years.

The invention provides a fire sprinkler valve trigger. The trigger comprises an elongated body with a longitudinal axis and a hollow therein void of material. The body is segmented into opposite segments by a cut in the body. The opposite segments are joined together, defining a joint between the opposite segments. A fusible material is disposed in the joint between the opposite segments, and joins the opposite segments together, and defines a failure point in the body between the opposite segments. The fusible material has a melting temperature less than a melting temperature of the opposite segments.

In accordance with a more detailed aspect of the invention, the trigger can further comprise a bore extending through the body along the longitudinal axis and defining the hollow and opposite open ends. The trigger can have an open end in the body open to the hollow. The body can be open to the hollow at opposite ends. The body can be a tube. Opposite ends of the body can have a fillet. Opposite ends of the body have a bevel or a chamfer. Opposite ends of the body can be crimped.

In addition, the invention provides a fire sprinkler valve. The fire sprinkler valve comprises a frame or yoke with a pipe attachment, a bore and a diverter. The fire sprinkler vale is configured to be coupled to a pipe with the pipe attachment, and receive a flow of a fire suppression fluid from the pipe and through the bore, and disperse the fire suppression fluid with the diverter. The fire sprinkler valve further comprises a plug engaging the bore and removably blocks the flow of the fire suppression fluid through the bore. A trigger is carried by the frame or yoke, and releasably maintains the plug in engagement with the bore. The trigger is elongated and has a length defined between distal retained ends. The trigger has a hollow therein void of material. The trigger is segmented into opposite segments by a cut in the trigger oriented at an acute angle transverse with respect to a length of the trigger. The opposite segments are joined together defining a joint between the opposite segments. A fusible material is disposed in the joint between the opposite segments and joins the opposite segments together, and defines a failure point in the trigger between the opposite segments. The opposite segments are joined together solely by the fusible material. The fusible material has a melting temperature less than a melting temperature of the opposite segments.

In accordance with a more detailed aspect of the invention, the fire sprinkler valve can further comprise an open end in the trigger open to the hollow. The open end can abut to the plug or the frame or yoke. The trigger can be open to the hollow at opposite ends defining open ends. One open end can abut to the plug, and the other open end can abut to the frame or yoke. The trigger can be a tube.

Furthermore, the invention provides a fire sprinkler valve. The fire sprinkler valve comprises a frame or yoke with a pipe attachment, a bore and a diverter. The fire sprinkler valve is configured to be coupled to a pipe with the pipe attachment, and receive a flow of a fire suppression fluid from the pipe and through the bore, and disperse the fire suppression fluid with the diverter. A plug engages the bore and removably blocks the flow of the fire suppression fluid through the bore. A trigger is carried by the frame or yoke and releasably maintains the plug in engagement with the bore. The trigger is elongated and has a length defined between distal retained ends. The trigger has a hollow therein void of material. An exterior of the trigger comprises a layer added to the exterior of the trigger. The layer comprises a preselected color corresponding to and designating the melting temperature of the fusible material. An entire length of the trigger between the distal retained ends is exposed and visible during use. The layer on the exterior of the trigger is disposed along an entire length of the trigger between the distal retained ends so that the layer on the exterior of the trigger is exposed and visible during use.

### BRIEF DESCRIPTION OF THE DRAWINGS

Additional features and advantages of the invention will be apparent from the detailed description which follows, taken in conjunction with the accompanying drawings, which together illustrate, by way of example, features of the invention; and, wherein:

FIG. 1a is a side view of a fire sprinkler valve or head shown with a heat-sensitive trigger in accordance with an embodiment of the present invention, and showing that the heat-sensitive trigger is exposed and visible during use and that the heat-sensitive trigger has an exposed surface or layer with a preselected color corresponding to and designating a melting temperature of a fusible material that is also exposed and visible during use;

FIG. 1b is a cross-sectional side view of the fire sprinkler valve or head with the heat-sensitive trigger of FIG. 1a, taken along a vertical line or plane through a longitudinal axis of the fire sprinkler valve;

FIG. 2a is a side view of the heat-sensitive trigger of FIG. 1a, showing a metal capsule segmented into halves or segments joined by a fusible material and defining a joint between the halves or segments;

FIG. 2b is another side view of the heat-sensitive trigger of FIG. 1a;

FIG. 3 is a cross-sectional side view of the heat-sensitive trigger of FIG. 1a, taken along a vertical line or plane through a longitudinal axis of the heat-sensitive trigger, showing the heat-sensitive trigger as a hollow, enclosed or sealed capsule void of material other than atmospheric air, and showing the joint or the fusible material as a ring;

FIG. 4 is a cross-sectional side view of another heat-sensitive trigger in accordance with another embodiment of the present invention, showing a disc or plate extending through the joint of the hollow metal capsule and formed of a thermally conductive material to facilitate and/or accelerate melting of the fusible material;

FIG. 5 is a cross-sectional side view of another heat-sensitive trigger in accordance with another embodiment of the present invention, showing a pair of joints in the hollow metal capsule oriented to form a wedge element between the halves or segments of the heat-sensitive trigger;

FIG. 6 is a cross-sectional side view of another heat-sensitive trigger in accordance with another embodiment of the present invention, showing the heat-sensitive trigger as a solid metal bar that is exposed and visible during use and with an exterior surface or layer with a preselected color corresponding to and designating a melting temperature of a fusible material that is also exposed and visible during use;

FIG. 7 is a cross-sectional side view of another heat-sensitive trigger in accordance with another embodiment of the present invention showing a disc or plate extending through the joint of the solid metal rod and formed of a thermally conductive material to facilitate and/or accelerate melting of the fusible material;

FIG. 8 is a cross-sectional side view of another heat-sensitive trigger in accordance with another embodiment of the present invention, showing a pair of joints in the solid metal bar oriented to form a wedge element between the halves or segments of the heat-sensitive trigger and showing the joints extending entirely through the bar;

FIG. 9 is a cross-sectional side view of another heat-sensitive trigger in accordance with another embodiment of the present invention, showing a pair of joints in the solid metal bar oriented to form a wedge element between the halves or segments of the heat-sensitive trigger, and showing the joints extending a majority, but partially, through the bar;

FIG. 10 is a cross-sectional side view of another heat-sensitive trigger in accordance with another embodiment of the present invention, and showing the heat-sensitive trigger as a solid metal bar with a core therein formed of a thermally conductive material to facilitate and/or accelerate melting of the fusible material;

FIG. 11a is a side view of the tire sprinkler valve or head of FIG. 1a shown with the joint and the fusible material of the heat-sensitive trigger at a predetermined melting temperature allowing the segments to separate, and allowing the plug to unseat and disperse the fire suppression fluid;

FIG. 11b is a cross-sectional side view of the fire sprinkler valve or head of FIG. 1a shown with the joint and the fusible material of the heat-sensitive trigger at a predetermined melting temperature allowing the segments to separate, and allowing the plug to unseat and disperse the fire suppression fluid;

FIG. 12a is a cross-sectional side view of the fire sprinkler valve or head with a heat-sensitive trigger in accordance with another embodiment of the present invention, and showing that the heat-sensitive trigger is exposed and visible during use and that the heat-sensitive trigger has an exposed surface or layer with a preselected color corresponding to and designating a melting temperature of a fusible material that is also exposed and visible during use;

FIG. 12b is a cross-sectional side view of the fire sprinkler valve or head of FIG. 12a shown with the joint and the fusible material of the heat-sensitive trigger at a predetermined melting temperature allowing the segments to separate, and allowing the plug to unseat and disperse the fire suppression fluid;

FIG. 13a is a side view of the heat-sensitive trigger of FIG. 12a, showing a tube segmented into halves or segments joined by a fusible material and defining a joint between the halves or segments;

FIG. 13b is another side view of the heat-sensitive trigger of FIG. 12a;

FIG. 14 is a cross-sectional side view of the heat-sensitive trigger of FIG. 12a, taken along a vertical line or plane through a longitudinal axis of the heat-sensitive trigger, showing the heat-sensitive trigger as a hollow tube, void of material other than atmospheric air, and showing the joint or the fusible material as a ring;

FIG. 15a is a partial, detailed, cross-sectional side view of the heat-sensitive trigger of FIG. 12a, showing a fillet in an end of the tube;

FIG. 15b is a partial, detailed, cross-sectional side view of the heat-sensitive trigger of FIG. 12a, showing a bevel or a chamfer or a miter in Ian end of the tube;

FIG. 15a is a partial, detailed, cross-sectional side view of the heat-sensitive trigger of FIG. 12a, showing a crimp in an end of the tube:

FIG. 15d is a partial, detailed, cross-sectional side view of the heat-sensitive trigger of FIG. 12a, showing a blunt end of the tube;

FIG. 16 is a cross-sectional side view of another heat-sensitive trigger in accordance with another embodiment of the present invention, showing a disc or plate extending through the joint of the hollow tube and formed of a thermally conductive material to facilitate and/or accelerate melting of the fusible material; and

FIG. 17 is a cross-sectional side view of another heat-sensitive trigger in accordance with another embodiment of the present invention, showing a pair of joints in the hollow metal capsule oriented to form a wedge element between the halves or segments of the heat-sensitive trigger.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

### Description

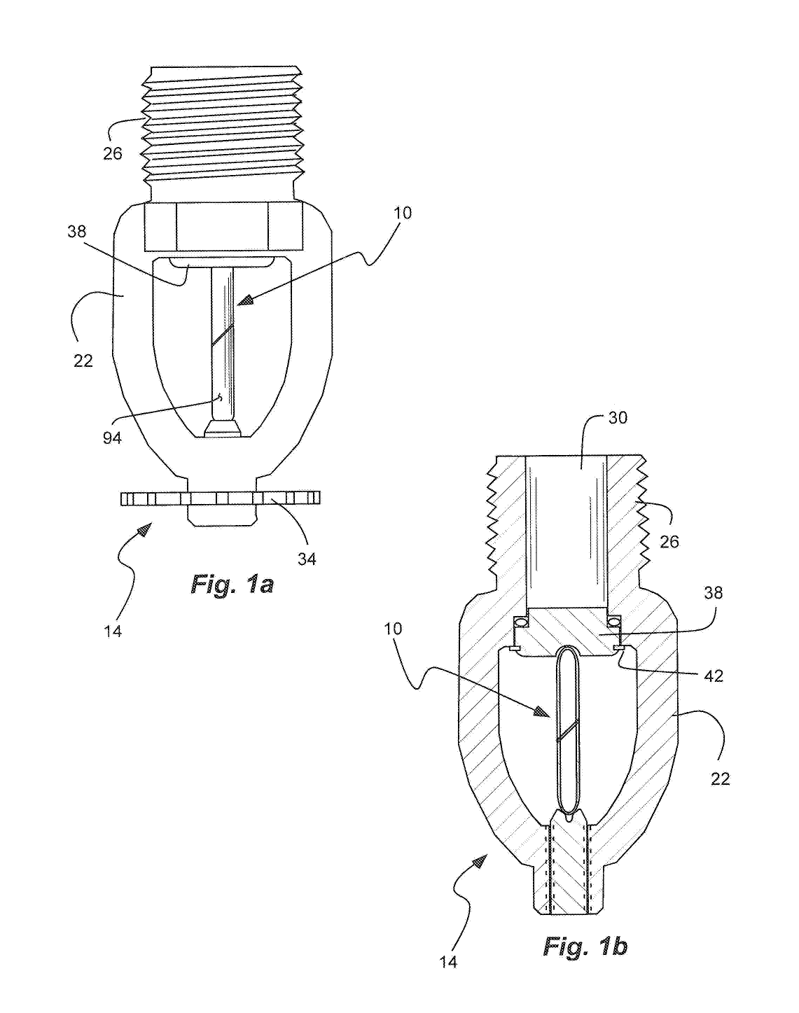

As illustrated in FIGS. 1a-3, a heat-sensitive trigger, indicated generally at 10, in an example implementation in accordance with the invention is show for use with a fire sprinkler valve or head 14. The trigger 10 can resemble, and can have similar or the same physical shape and dimensions as, a glass bulb type trigger. Thus, the present trigger 10 can be used to easily replace the prior glass bulb type trigger in existing fire sprinkler valves, and/or can be used with the existing designs of fire sprinkler valves. The trigger 10, however, can be formed of metal, and without any glass, to resist inadvertent fracture of the trigger during assembly with a fire sprinkler valve, shipment, installation, and/or use. Thus, the trigger is more robust. In addition, the trigger 10 can be colored to designate a predetermined heat rating or temperature characteristic of the trigger. The heat rating of the trigger, and thus the fire sprinkler valve, can he readily identified by simple observation. The trigger can be formed without any liquid to resist discoloration or fading, and thus confusion as to the temperature rating thereof. In addition, the trigger can be configured to have a response time index (RTI) as good or better than glass bulb type triggers (e.g. of less than 50 ms^{1/2}). Furthermore, the trigger can be formed of a material that is not susceptible to hairline cracks.

The fire sprinkler valve or head 14 can comprise a frame or yoke 22 having a pipe attachment 26, a bore 30 through the pipe attachment, and a diverter 34 carried by the frame or yoke 22 and located opposite the bore. The pipe attachment 26, and thus the frame or yoke 22, can connect or couple to a pipe, such as with pipe threads or a threaded connection. The pipe is coupled to a source of fire suppression fluid so that the fire sprinkler valve or head can receive a flow of a fire suppression fluid from the pipe, through the bore, and disperse the fire suppression fluid with the diverter 34. The fire sprinkler valve or head 14 can be one of a plurality or network of such valves or heads in a pipe system to strategically locate the vales or heads through a building or facility. In one aspect, sprinkler system can be a wet-pipe system and the fire suppression fluid can comprise a liquid, such as water. In another aspect, the sprinkler system can be a dry-pipe system with pressurized air in the pipe prior to receiving the fire suppression fluid or water.

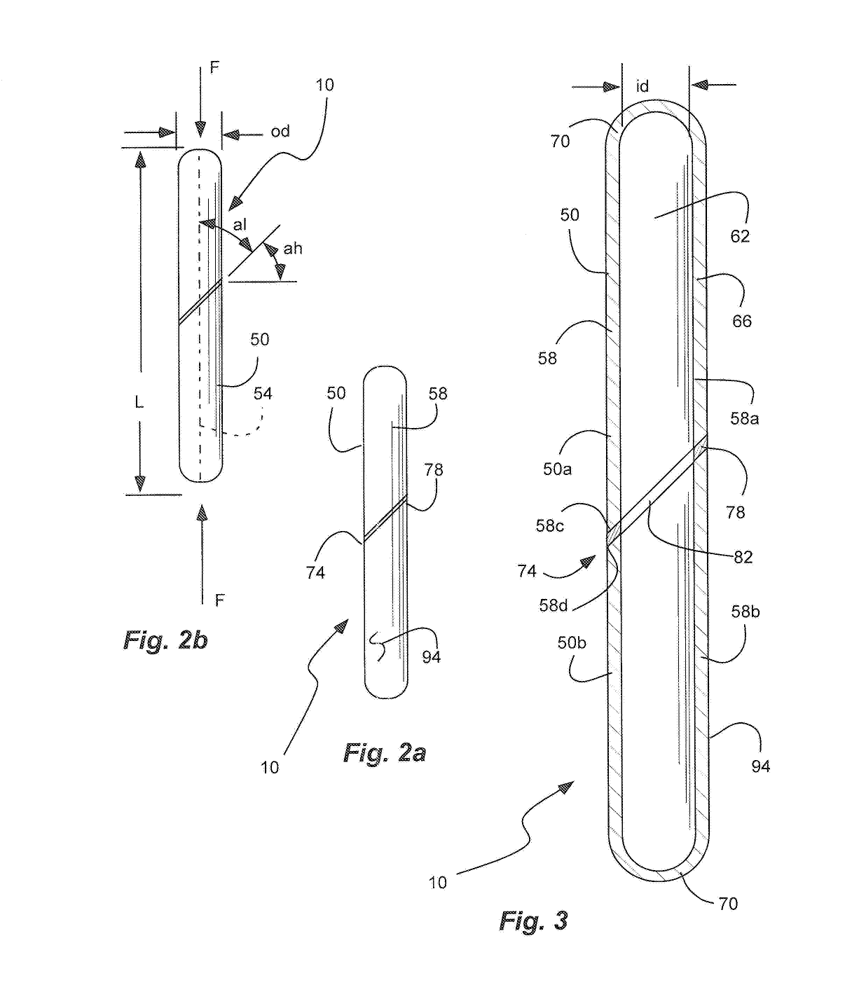

A plug 38 or cap is carried by the frame or yoke 22, and can engage the bore and removably block the flow of the fire suppression fluid through the bore 30. The plug 38 can be wholly or partially disposed in the bore 30. A portion of the frame or yoke (such as that carrying the diverter) can be disposed opposing and spaced-apart from the bore 30 and the plug 38. The trigger 10 is carried by the frame or yoke and disposed in the space between the plug 38 and the opposing portion of the frame or yoke. The trigger 10 releasably maintains the plug 38 in engagement with the bore 30, and thus keeps the bore closed and prevents the release of the fire suppression fluid. The trigger 10 can be held in compression between the plug 38 and the opposing portion of the frame or yoke 22. In one aspect, the compressive force F (FIG. 2b) can be applied by the pressure of the fire suppression fluid on the plug. In another aspect, the compressive force can be applied by a spring 42 carried by the frame or yoke. In another aspect the compressive force can be applied by the pressure of the fire suppression fluid on the plug and the spring carried by the frame or yoke.

The heat-sensitive trigger 10 for the fire sprinkler valve or head 14 can comprise an elongated metal body 50 or rod or capsule with a longitudinal axis 54. In one aspect, the trigger 10 or body 50 can be an enclosed metal capsule 58 with a hollow interior 62. The capsule 58 can be sealed, and the hollow interior 62, can be void of material (except for naturally occurring ambient air). Thus, the capsule 58 can be sealed, and the hollow interior 62, can be void of liquid or solid material (although it can contain a gas, namely ambient air). In addition, capsule 58, and/or the hollow interior 62, can be unpressurized, or have substantially the same pressure inside as ambient pressure (except for a slight pressure differential or slight vacuum or negative pressure introduced during manufacture due to heat; and/or a slight pressure differential or slight vacuum or negative pressure or even positive pressure due to different elevational pressure between point of manufacture and point of installation). The capsule 58 can have an annular cross-sectional shape taken transverse to the longitudinal axis 54. In addition, the capsule 58 can have an annular or cylindrical lateral wall 66 closed at the ends by end walls 70. The body 50 and/or capsule 58 can be sized and shaped to be used with existing designs for fire sprinkler valves or heads 14. Thus, the body 50 and/or the capsule 58 can be elongated and can have a length L (FIG. 2b). The ends of the body or the capsule can be retained by the fire sprinkler valve 14 (such as by the frame or yoke 22 on one end and the plug 38 on the other end), defining distal retainable ends, and with the length defined between the distal retainable ends. The body 50 and/or capsule 58 can be formed of metal, and can have a high thermal conductivity. In one aspect, the body 50 and/or capsule 58 can be formed of metal, such as aluminum, and can have a thermal conductivity of 205±20 W/mK. Thus, ambient heat will be conducted readily through the body or capsule. The capsule 58 can be formed by machining, casting, or extruding a tube and pinching and heating the ends to form an enclosure.

The body 50 and/or capsule 58 can be segmented into opposite segments 50a and 50b or 58a and 58b by a cut or seam in the body or the capsule. In one aspect, the body or capsule can be formed, and then segmented or cut. In another aspect, the opposite segments can be separately formed and then joined together to define the cut or segments. The opposite segments can be joined together defining a joint 74 or seam between the opposite segments. The segments can be fixedly or rigidly joined together at the joint. In one aspect, the cut and/or the joint 74 can extend entirely through the body or capsule (as shown in FIGS. 2a-8 and 19). Thus, the segments can separate by slipping with respect to one another. In another aspect, the cut and/or the joint 74 can extend substantially through the body or capsule, or mostly or through a majority of the body or capsule, but not entirely through the body or capsule leaving a narrow neck or connection between the segments (as shown in FIG. 9). Thus, the segments can separate by pivoting or bending with respect to one another. In one aspect, the cut can be oriented at an acute angle transverse with respect to the longitudinal axis 54. Thus, the angle can facilitate sliding of the segments with respect to one another during separation.

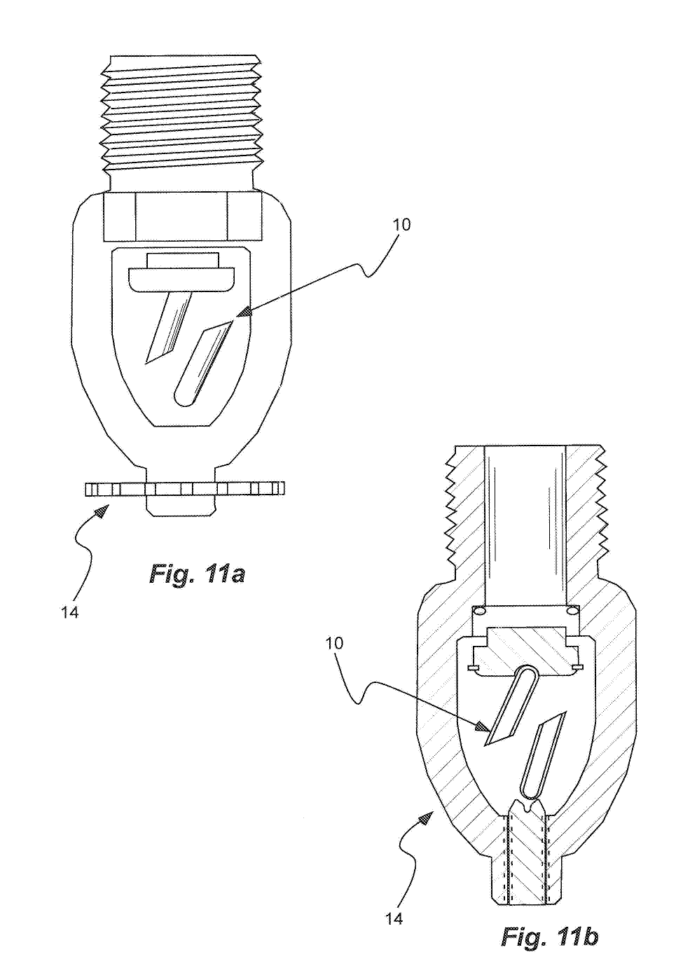

A fusible material 78 can be disposed in the joint 74 between the opposite segments, and joining the opposite segments together. The fusible material can be heated to melt the fusible material between the opposite segments to join the opposite segments, such as by soldering. As described above, the capsule can have an annular cross-sectional shape taken transverse to the longitudinal axis. Thus, the opposite segments can have opposing annular faces 58c and 58d contacting the fusible material 78. The fusible material 78 can form a ring 82 disposed between the opposing annular faces 58c and 58d. In one aspect, the opposite segments can be joined together solely by the fusible material 78, without any exterior support structure (so that the body or capsule is exposed, as described below). The fusible material 78 and the joint 74 and the ring 82 can define a failure point in the body or capsule between the opposite segments, and about which the segments can separate when the fusible material is heated. The fusible material 78 can have a melting temperature less than a melting temperature of the opposite segments of the body or capsule. The fusible material can be selected and/or design to melt at a desires ambient temperature associated with a fire in the building or facility. The ambient temperature can be readily conducted through the metal body or capsule, or segments thereof, to the joint and the fusible material 78; which melts upon reaching a predetermined melting temperature; allowing the segments to separate; thus allowing the plug to unseat and disperse the fire suppression fluid, as shown in FIGS. 11a and 11b.

The annular cross-sectional shape of the capsule 58 can allow an exterior surface area of the capsule to be maximized to facilitate or accelerate heating of the capsule by the ambient air. In addition, the annular cross-sectional shape of the capsule 58 can concentrate the fusible material 78 in the ring 82 at the outer surface of the capsule to facilitate or accelerate melting of the fusible material or ring. The thickness of the annular wall 66, and/or the inner diameter id or width of the hollow interior 62, can be designed to tailor the surface area of the opposing annular faces 58c and 58d, and/or the surface area of the fusible material 78 or ring 82. In one aspect, a surface area of one of the opposite segments or opposing annular faces 58c and 58d is less than 0.01 square inches. In another aspect, the body or capsule can have a width or diameter od (FIG. 2b) at the joint 74 of less than 0.1875 inches. The body or capsule, and thus the trigger 10, can he designed to have a rapid response time index (RTI). In one aspect, the body or capsule can be designed to have a rapid response time index (RTI) of less than 50 ms^{1/2}. Thus, the body or capsule can have a mass less than 0.92 grams; and a diameter od less than 0.1875 inches, and a volume less than 0.02 cubic inches (0.34 cubic centimeters) of material creating the capsule. The body or capsule can have a length L between 0.375 to 0.87 inches. In one aspect, the fusible material 78 and the joint 74 and the ring 82 can be oriented at an angle al between 45 to 60 degrees with respect to the longitudinal axis (or an angle ah between 30 to 45 degrees with respect to horizontal when the body or the capsule is oriented vertically). The fusible material 78 and the joint 74 and the ring 82 can be oriented at an angle ah between 30 to 55 degrees in one aspect, 35 to 50 degrees in another aspect, or 40-55 degrees in another aspect, with respect to horizontal when the body or the capsule is oriented vertically. The greater angle with respect to the longitudinal axis (or lesser the angle with respect to horizontal when the capsule is oriented vertically) can reduce shear tension in the fusible material and/or joint. In another aspect, the body 50 or the capsule 58 can have an exterior with a circular cross sectional shape to maximize exposed surface area to ambient temperature, and to minimize internal surface area contacting the fusible material.

As described above, the trigger 10 can also have an exterior of the body 50 or the capsule 58, and the joint 74 and the fusible material 78 or the ring 82, that is exposed and visible during use, or when installed in the fire sprinkler valve or head 14. Thus, the entire length L of the body 50 or the capsule 58 between the distal retained ends can be exposed (i.e. the portion between the distal retained ends is exposed while the distal retained ends themselves may be covered by the frame or yoke 22 on one end and the plug 38 on the other end). As described above, the opposite segments can be joined together solely by the fusible material 78, free of any exterior support structure, so that the body or the capsule is exposed and visible. Having a visible trigger (the body or the capsule and the fusible material 78 and the joint 74) allows the trigger to be visually inspected without disassembly or removal. In one aspect, the body or the capsule can be cylindrical so that an entire exterior surface faces radially outwardly. In addition, the opposite segments can be joined together solely by the fusible material, and unrestrained or unrestricted by any exterior structure, so that the body or capsule has a free slip plane, defined by the joint 74.

The exterior of the body 50 or the capsule 58 comprises a layer 94 added to the exterior of the body or the capsule. The layer 94 comprises a preselected color corresponding to and designating a predetermined and selected melting temperature of the fusible material 78. As described above, the body or the capsule, including the joint and the fusible material, is exposed and visible during use. Thus, the layer 94 on the exterior of the body or capsule is exposed and visible during use, or when installed in the fire sprinkler valve or head 14. Having the layer 94 visible, and thus the color and the corresponding melting temperature of the joint and the fusible material, allows the heat rating of the trigger and the fire sprinkler valve to be immediately identified. In one aspect, the layer 94 can be formed on a portion of the body or the capsule. A length of the body or the capsule can be exposed along at least 50% of the length, defining an exposed length. The layer 94 on the exterior of the body or the capsule can be disposed along an entire length of the exposed length. In another aspect, the layer 94 can be formed on the entire body or the entire capsule (or visible portion thereof when installed on the fire sprinkler valve). The layer 94 on the exterior of the body or the capsule can be disposed along an entire length L of the body or the capsule between the distal retainable ends. In one aspect, the layer can be integral with the material, such as by anodizing forming an anodized layer. In another aspect, the layer can be a separate and discrete layer covering the exterior or the body or the capsule, such as paint or dye. In one aspect, the layer 94 on the exterior of the body or the capsule can be disposed immediately adjacent to the joint 74 and immediately adjacent to the fusible material 78 so that the temperature rating and the trigger can be simultaneously identified and inspected.

Different triggers with different fusible materials in the joints thereof can be provided in different fire sprinkler valves for different heat ratings or applications. The different triggers, or bodies or capsules thereof; can have different layers with different colors corresponding to the different melting temperatures of the fusible materials.

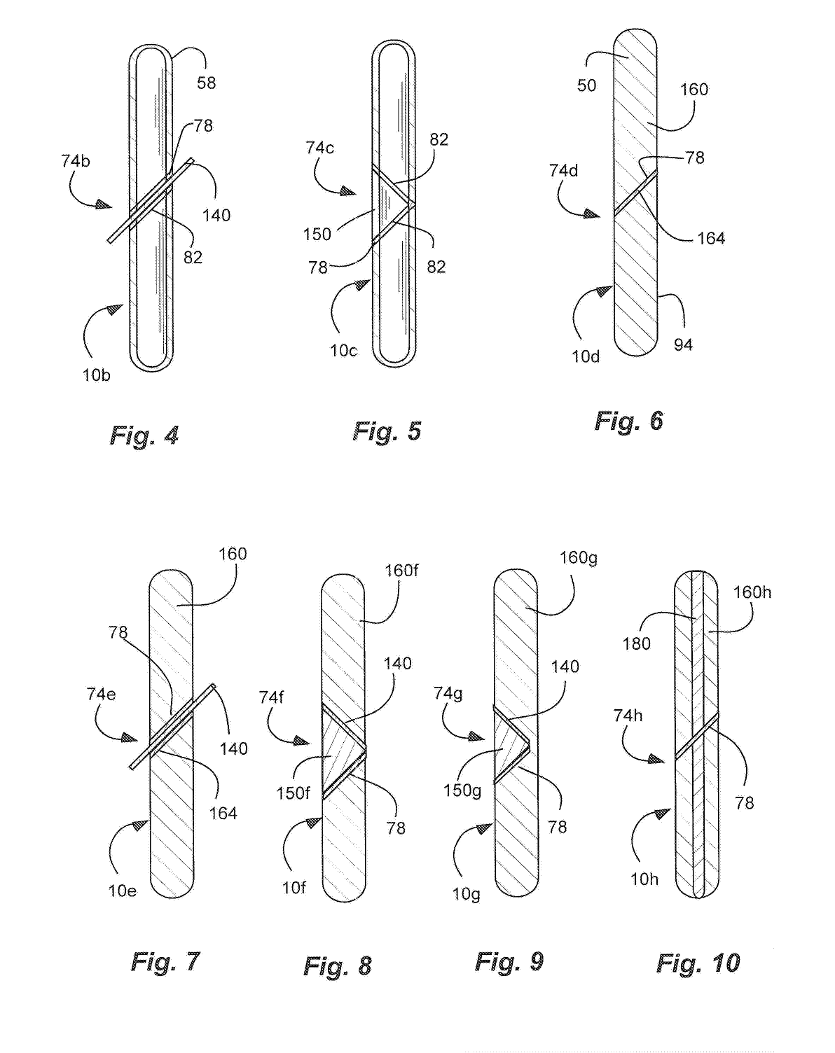

Referring to FIG. 4, another heat-sensitive trigger 10b in accordance with another embodiment of the present invention is shown in cross-section. The trigger 10b is similar in many respects to that described above, and which description is applicable to the present trigger, or is hereby incorporated by reference herein. The trigger 10b has a disc or plate 140 extending through the joint 74b of the hollow metal capsule 58. The disc or plate 140 is formed of a thermally conductive material, such as aluminum, to facilitate and/or accelerate melting of the fusible material 78. The disc or plate 140 can provide greater surface area to be heated by the ambient air or temperature, and can have high thermal conductivity to transfer that heat to the joint 74b to melt the fusible material 78. In one aspect, the disc or plate 140 can be sandwiched between the segments, and between the fusible materials 78. Thus, the fusible material 78 can be disposed on both sides of the disc or plate 140, and there can be two rings 82, each on an opposite side of the disc or plate 140.

Referring to FIG. 5, another heat-sensitive trigger 10c in accordance with another embodiment of the present invention is shown in cross-section. The trigger 10c is similar in many respects to those described above, and which descriptions are applicable to the present trigger, or are hereby incorporated by reference herein. The trigger 10c has a joint 74c, or a pair of joints 74c, with a pair of cuts or seams, and a pair of rings 82, in the hollow metal capsule 58. The pair of joints or cuts are oriented to form a wedge element 150 between the halves or segments of the capsule. The pair of joints and/or the wedge element can allow the halves or segments of the capsule to pivot or bend with respect to one another as a primary movement path or failure path, rather than slide. Thus, the halves or segments can collapse towards one another as the fusible material 78 melts. In one aspect, the wedge element can form a cylinder with opposite angled ends. In another aspect, the wedge element can be open and can form an arc.

In one aspect, the capsule or bulb described above can provide an interior hollow that is void of material. The hollow interior can facilitate manufacture, and reduce failures or inconsistent operation due to leaks. In another aspect, the capsule or bulb can have a liquid, such as glycerin, therein to supplement the fracture of the joint.

In one aspect, the capsule or bulb described above can be sealed to resist fouling. In another aspect, the capsule or bulb can have openings therein, such as at the ends, or lateral apertures in the cylindrical walls, to allow ambient air and ambient temperature therein to facilitate head transfer to the fusible material in the joint.

In one aspect, the capsule or bulb described above can have straight cylindrical walls to facilitate manufacture. In another aspect, the capsule or bulb can have non-straight or non-linear walls. For example, the capsule or bulb can have bulbous ends to facilitate seating in the frame or yoke and the plug.

In one aspect, the capsule or bulb described above can provide a hollow cylinder with a greater outer diameter and a lesser mass that a solid bar of equal diameter. Thus, the hollow cylinder can provide good structural rigidity and compression strength due to its outer diameter, while also providing rapid heat transfer due to its lesser mass. In addition, the hollow cylinder can reduce the surface area of the opposing annular faces contacting the fusible material, while maintaining structural rigidity and compression strength, and reducing the response time index (RTI) of the trigger. Furthermore, the hollow cylinder can provide good visibility or the exterior layer and color thereof to facilitate visibility and identification, without compromising the response time index (RTI) of the trigger. In another aspect, the body can comprise a solid metal rod or bar. A solid metal rod or bar can facilitate manufacture, and can have good rigidity and compression strength.

Referring to FIG. 6, another heat-sensitive trigger 10d in accordance with another embodiment of the present invention is shown in cross-section. The trigger 10d is similar in many respects to those described above, and which descriptions are applicable to the present trigger, or are hereby incorporated by reference herein. The trigger 10d has a body 50 that is a solid metal body or bar 160 that is segmented into opposite segments or opposite bars or rods jointed together at a joint 74d with fusible material 78. The bar 160 can be formed by extrusion and then cutting or crimping to length. The fusible material can be disposed in or formed in a disc 164. In addition, as described above, the solid body or bar is exposed and visible during use and with an exterior surface or layer 94 with a preselected color corresponding to and designating a melting temperature of a fusible material that is also exposed and visible during use.

Referring to FIG. 7, another heat-sensitive trigger 10e in accordance with another embodiment of the present invention is shown in cross-section. The trigger 10e is similar in many respects to those described above, and which descriptions are applicable to the present trigger, or are hereby incorporated by reference herein. The trigger 10e has a disc or plate 140 extending through the joint 74e of the solid metal body or rod 160 that is segmented into opposite segments or opposite bars or rods jointed together at a joint 74e with fusible material 78. The disc or plate 140 is formed of a thermally conductive material, such as aluminum, to facilitate and/or accelerate melting of the fusible material 78. The disc or plate 140 can provide greater surface area to be heated by the ambient air or temperature, and can have high thermal conductivity to transfer that heat to the joint 74e to melt the fusible material 78. In one aspect, the disc or plate 140 can be sandwiched between the segments, and between the fusible materials 78. Thus, the fusible material 78 can be disposed on both sides of the disc or plate 140, and there can be two discs 164, each on an opposite side of the disc or plate 140.

Referring to FIGS. 8 and 9, other heat-sensitive triggers 10f and 10g in accordance with other embodiments of the present invention are shown in cross-section. The triggers 10f and 10g are similar in many respects to those described above, and which descriptions are applicable to the present triggers, or are hereby incorporated by reference herein. The triggers 10f and 10g have a joint 74f or 74g, or a pair of joints 74f or 74g, with a pair of cuts or seams, and a pair of discs or plates 40, in the solid metal bodies or rods 160f or 160g. The pair of joints or cuts arc oriented to form a wedge element 150f or 150g between the halves or segments of the bodies or rods. In one aspect, the cuts or joints can extend through the body or rod 160f, and the wedge element 150f can form a bar with opposite angled ends and a diameter equal to the body or rod, as shown in FIG. 8. In another aspect, the cuts or joints can extend partially through the body or rod 160g, and the wedge element 150g can form a bar with opposite angled ends and a diameter less than the body or rod, as shown in FIG. 9. The pair of joints and/or the wedge elements can allow the halves or segments of the bodies or rods to pivot or bend with respect to one another as a primary movement path or failure path, rather than slide. Thus, the halves or segments can collapse towards one another as the fusible material 78 melts.

Referring to FIG. 10, another heat-sensitive trigger 10h in accordance with another embodiment of the present invention is shown in cross-section. The trigger 10h is similar in many respects to those described above, and which descriptions are applicable to the present trigger, or are hereby incorporated by reference herein. The trigger 10h has a solid metal body or bar 160h with a core 180 therein formed of a thermally conductive material to facilitate and/or accelerate melting of the fusible material 78. The core 180 can extend along a longitudinal interior of the body to the joint 74h. The core 180 can include a different material than the body or rod, such as copper.

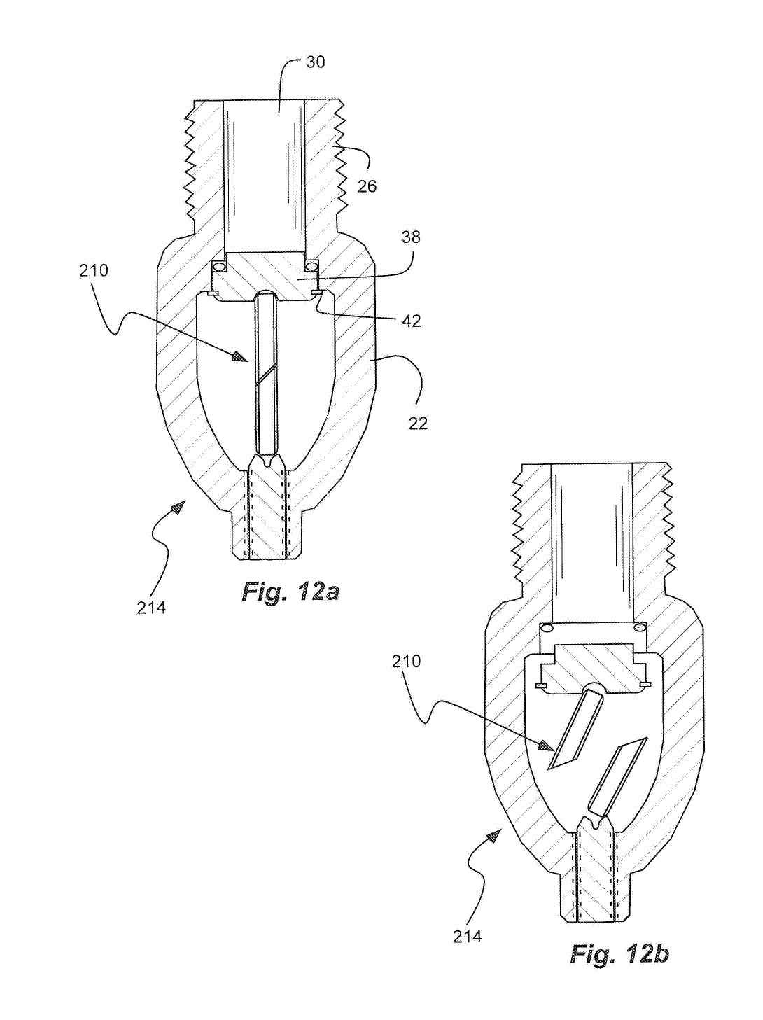

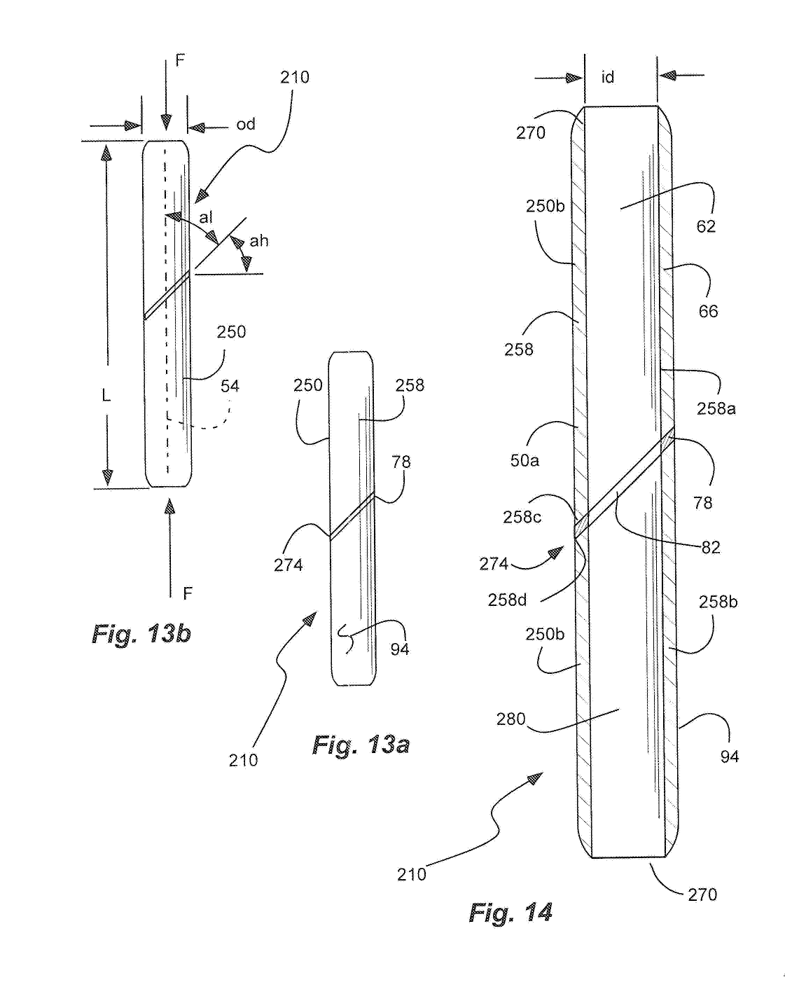

Referring to FIGS. 12a-15c, another heat-sensitive trigger, indicated generally at 210, in an example implementation in accordance with the invention is show for use with a fire sprinkler valve or head 214. The trigger 210 is similar in many respects to that described above, and which description is hereby incorporated herein by reference. In addition, the fire sprinkler valve or head 214 is similar in most respects to that described above, and which description is hereby incorporated herein by reference.

The heat-sensitive trigger 210 for the fire sprinkler valve or head 214 can comprise an elongated body 250 with distal retained ends and a longitudinal axis 54. In one aspect, the trigger 210 or the body 250 can be an open tube 258 with an elongated hollow or hollow interior 62 and opposite open ends 270. Thus, the distal retained ends can be open. The hollow or hollow interior 62 can be void of material (except for naturally occurring ambient air). Thus, the hollow or hollow interior 62, can be void of liquid or solid material (although it can contain a gas, namely ambient In one aspect, the trigger 210 or the body 250 can have a bore 280 extending through the body 250 along the longitudinal axis 54. The bore 280 can form the hollow or hollow interior 62, and can form or define the opposite open ends 270. In one aspect, the trigger 210 or the body 250 can have at least one open end 270 in the body open to the hollow or hollow interior 62. The open end 270 can abut to the plug 38 or the frame or yoke 22. Or the open end 270 can be coupled to or can engage the plug 38 or the frame or yoke 22. In another aspect, the trigger 210 or the body 250 is open to the hollow at both opposite ends. One open end 270 can abut to the plug 38, and the other open end 270 can abut to the frame or yoke 22. In one aspect, the plug 38 and the frame or yoke 22 can be open to the open ends 270 of the tube 258 to allow air and/or heat to flow Into the hollow or hollow interior 62. In another aspect, the plug 38 and the frame or yoke 22 can close the open ends 270 of the tube 258, forming an enclosed capsule. In one aspect, the tube 258 can be a single, unitary and rigid tube extending between the plug 38 and the frame or yoke 22. In another aspect, the tube 258 can have a constant cross-section shape along its entire length, and a constant inner and/or outer diameter along its entire length. The constant cross-section and constant diameters can facilitate manufacture. The tube with the at least one open end, or open therethrough, can facilitate inspection during manufacturing, and can facilitate heat transfer in use by exposing both the exterior and interior surfaces to ambient temperature. In one aspect, the body or tube can be metal. The body or tube can be formed by extrusion or machining.

The body 250 and/or tube 258 can be segmented into opposite segments 250a and 250b or 258a and 258b by a cut or scam in the body 250 or the tube 258. In one aspect, the body or tube can be formed, and then segmented or cut. In another aspect, the opposite segments can be separately formed and then joined together to define the cut or segments. The opposite segments 250a and 250b or 258a and 258b can be joined together defining a joint 274 or seam between the opposite segments. The segments 250a and 250b or 258a and 258b can be fixedly or rigidly joined together at the joint. In one aspect, the cut and/or the joint 274 can extend entirely through the body 250 or tube 258. Thus, the segments can separate by slipping with respect to one another. In another aspect, the cut and/or the joint can extend substantially through the body or tube, or mostly or through a majority of the body or tube, but not entirely through the body or tube leaving a narrow neck or connection between the segments. Thus, the segments can separate by pivoting or bending with respect to one another. In one aspect, the cut can be oriented at an acute angle transverse with respect to the longitudinal axis 54. Thus, the angle can facilitate sliding of the segments with respect to one another during separation.

A fusible material 78 can be disposed in the joint 74 between the opposite segments 250a and 250b or 258a and 258b, and joining the opposite segments together. The fusible material can be heated to melt the fusible material between the opposite segments to join the opposite segments, such as by soldering. The tube 258 can have an annular cross-sectional shape taken transverse to the longitudinal axis. Thus, the opposite segments 258a and 258b can have opposing annular faces 258c and 258d contacting the fusible material 78. The fusible material 78 can form a ring 82 disposed between the opposing annular faces 258c and 258d. In one aspect, the opposite segments can be joined together solely by the fusible material 78, without any exterior support structure (so that the body or tube is exposed, as described below). The fusible material 78 and the joint 274 and the ring 82 can define a failure point in the body or tube between the opposite segments, and about which the segments can separate when the fusible material is heated. The fusible material 78 can have a melting temperature less than a melting temperature of the opposite segments of the body or tube. The fusible material can be selected and/or design to melt at a desires ambient temperature associated with a fire in the building or facility. The ambient temperature can be readily conducted through the metal body or capsule, or segments thereof, to the joint and the fusible material 78; which melts upon reaching a predetermined melting temperature; allowing the segments to separate: thus allowing the plug to unseat and disperse the fire suppression fluid, as shown in FIG. 12b.

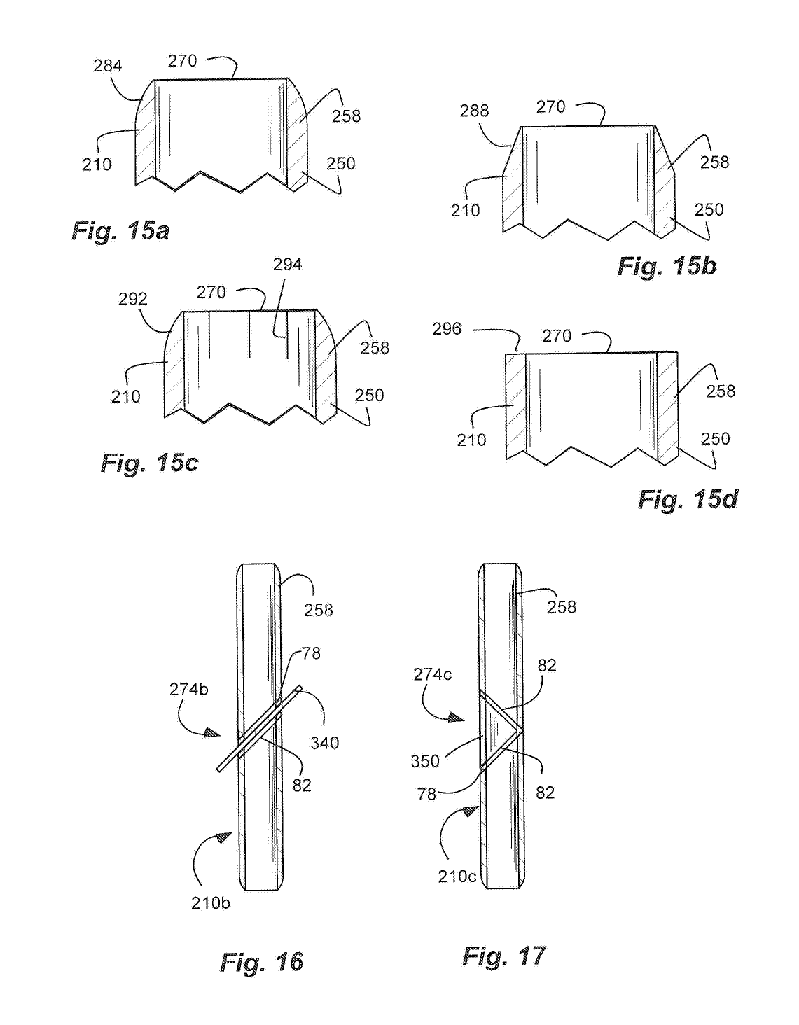

Referring to FIGS. 15a-c, one or both ends 270 of the trigger 210 or body 250 or tube 258 can be shaped to match and/or mate with the plug 38, frame or yoke 22, or other structure of the valve. The exterior of the trigger 210, body 250 or tube 258 can be shaped and/or sized to match and/or mate with the plug 38, frame or yoke 22, or other structure of the valve. In one aspect, one or both of the opposite ends 270 of the trigger 210, body 250 and/or tube 258 can have a fillet 284, as shown in FIG. 15a. The fillet 284 can comprise an exterior rounding of the exterior of the trigger 210, body 250 and/or tube 258 at the end. The fillet 284 can match the size and shape of a traditional bulb in the valve. In another aspect, one or both of the opposite ends 270 of the trigger 210, body 250 and/or tube 258 can have a bevel or a chamfer 288, as shown in FIG. 15b. The bevel or chamfer 288 can comprise an exterior angling of the exterior of the trigger 210, body 250 and/or tube 258 at the end. The bevel or chamfer 288 can he easier to manufacture while still mating with the plug 38, frame or yoke 22, or other structure of the valve. In another aspect, one or both of the opposite ends 270 of the trigger 210, body 250 and/or tube 258 can have a crimp or be crimped 292, as shown in FIG. 15c. The crimp 292 can comprise scoring (indicated at 294) and compressing the end of the trigger 210, body 250 and/or tube 258. The crimp 292 can be easier to manufacture while still mating with the plug 38, frame or yoke 22, or other structure of the valve. In another aspect, the one or both of the opposite ends 270 of the trigger 210, body 250 and/or tube 258 can be blunt 296, as shown in FIG. 15d. The blunt end 296 can be easier to manufacture.

Referring to FIG. 16, another heat-sensitive trigger 210b in accordance with another embodiment of the present invention is shown in cross-section. The trigger 210b is similar in many respects to that described above, and which description is applicable to the present trigger, or is hereby incorporated by reference herein. The trigger 210b has a disc or plate 340 extending through the joint 274b of the tube 258. The disc or plate 340 is formed of a thermally conductive material, such as aluminum, to facilitate and/or accelerate melting of the fusible material 78. The disc or plate 340 can provide greater surface area to be heated by the ambient air or temperature, and can have high thermal conductivity to transfer that heat to the joint 274b to melt the fusible material 78. In one aspect, the disc or plate 340 can be sandwiched between the segments 258a and 258b, and between the fusible materials 78. Thus, the fusible material 78 can'be disposed on both sides of the disc or plate 340, and there can be two rings 82, each on an opposite side of the disc or plate 340.

Referring to FIG. 17, another heat-sensitive trigger 210c in accordance with another embodiment of the present invention is shown in cross-section. The trigger 210c is similar in many respects to those described above, and which descriptions are applicable to the present trigger, or are hereby incorporated by reference herein. The trigger 10c has a joint 274c, or a pair of joints 274c, with a pair of cuts or seams, and a pair of rings 82, in the tube 258. The pair of joints 274c or cuts are oriented to form a wedge element 350 between the halves or segments of the tube 258. The pair of joints 274c and/or the wedge element 350 can allow the halves or segments of the tube to pivot or bend with respect to one another as a primary movement path or failure path, rather than slide. Thus, the halves or segments can collapse towards one another as the fusible material 78 melts. In one aspect, the wedge element can form a cylinder with opposite angled ends. In another aspect, the wedge element can be open and can form an arc.

The descriptions of the different embodiments apply to each other or the other embodiments. Thus, a feature or aspect described in one embodiment is applicable to another embodiment.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A fire sprinkler valve trigger, comprising:
a) an elongated body with a longitudinal axis and a hollow therein void of material;
b) the body being segmented into opposite segments by a cut in the body;
c) the opposite segments being joined together defining a joint between the opposite segments;
d) a fusible material disposed in the joint between the opposite segments and joining the opposite segments together, and defining a failure point in the body between the opposite segments; and
e) the fusible material having a melting temperature less than a melting temperature of the opposite segments.

2. The trigger in accordance with claim 1, further comprising a bore extending through the body along the longitudinal axis and defining the hollow and opposite open ends.

3. The trigger in accordance with claim 1, further comprising an open end in the body open to the hollow.

4. The trigger in accordance with claim 1, wherein the body is open to the hollow at opposite ends.

5. The trigger in accordance with claim 1, wherein the body is a tube.

6. The trigger in accordance with claim 1, wherein opposite ends of the body have a fillet.

7. The trigger in accordance with claim 1, wherein opposite ends of the body have a bevel or a chamfer.

8. The trigger in accordance with claim 1, wherein opposite ends of the body are crimped.

9. The trigger in accordance with claim 1, further comprising:
a) an exterior of the body comprising a layer added to the exterior of the body, the layer comprising a preselected color corresponding to and designating the inciting temperature of the fusible material; and
b) the body, including the joint and the fusible material, being exposed and visible during use so that the layer on the exterior of the body is exposed and visible during use.

10. The trigger in accordance with claim 1, wherein the opposite segments are joined together solely by the fusible material.

11. The trigger in accordance with claim 1, in combination with the fire sprinkler valve having a frame or yoke with a pipe attachment, a bore and a diverter, and with a plug engaging the bore and configured to removably block a flow of a fire suppression fluid through the bore, the body carried by the frame or yoke and releasably maintaining the plug in engagement with the bore.

12. A fire sprinkler valve, comprising;
a) a frame or yoke with a pipe attachment, a bore and a diverter, configured to be coupled to a pipe with the pipe attachment and receive a flow of a fire suppression fluid from the pipe and through the bore, and disperse the fire suppression fluid with the diverter;
b) a plug engaging the bore and removably blocking the flow of the fire suppression fluid through the bore;
e) a trigger carried by the frame or yoke and releasably maintaining the plug in engagement with the bore:
d) the trigger being elongated and having a length defined between distal retained ends;
e) the trigger having a hollow therein void of material;
f) the trigger being segmented into opposite segments by a cut in the trigger oriented at an acute angle transverse with respect to a length of the trigger;
g) the opposite segments being joined together defining a joint between the opposite segments;
h) a fusible material disposed in the joint between the opposite segments and joining the opposite segments together, and defining a failure point in the trigger between the opposite segments, with the opposite segments joined together solely by the fusible material; and
i) the fusible material having a melting temperature less than a melting temperature of the opposite segments.

13. The fire sprinkler valve in accordance with claim 12, further comprising an open end in the trigger open to the hollow; and wherein the open end abuts to the plug or the frame or yoke.

14. The fire sprinkler valve in accordance with claim 12, wherein the trigger is open to the hollow at opposite ends defining open ends; and wherein one open end abuts to the plug and the other open end abuts to the frame or yoke.

15. The fire sprinkler valve in accordance with claim 12, wherein the trigger is a tube.

16. The fire sprinkler valve in accordance with claim 12, wherein the trigger further comprises:
a) an exterior of the trigger comprising a layer added to the exterior of the trigger, the layer comprising a preselected color corresponding to and designating the melting temperature of the fusible material; and
b) an entire length of the trigger between the distal retained ends, including the joint and the fusible material, being exposed and visible during use, and the layer on the exterior of the trigger being disposed along an entire length of the trigger between the distal retained ends so that the layer on the exterior of the trigger is exposed and visible during use.

17. A fire sprinkler valve, comprising:
a) a frame or yoke with a pipe attachment, a bore and a diverter, configured to be coupled to a pipe with the pipe attachment and receive a flow of a fire suppression fluid from the pipe and through the bore, and disperse the fire suppression fluid with the diverter;
b) a plug engaging the bore and removably blocking the flow of the fire suppression fluid through the bore;
c) a trigger carried by the frame or yoke and releasably maintaining the plug in engagement with the bore;
d) the trigger being elongated and having a length defined between distal retained ends;
e) the trigger having a hollow therein void of material;
f) an exterior of the trigger comprising a layer added to the exterior of the trigger, the layer comprising a preselected color corresponding to and designating the melting temperature of the fusible material; and
g) an entire length of the trigger between the distal retained ends being exposed and visible during use, and the layer on the exterior of the trigger being disposed along an entire length of the trigger between the distal retained ends so that the layer on the exterior of the trigger is exposed and visible during use.

18. The fire sprinkler valve in accordance with claim 17, wherein the trigger further comprises:
a) the trigger being segmented into opposite segments by a cut in the trigger oriented at an acute angle transverse with respect to a length of the trigger;
b) the opposite segments being joined together defining a joint between the opposite segments;
c) a fusible material disposed in the joint between the opposite segments and joining the opposite segments together, and defining a failure point in the trigger between the opposite segments, with the opposite segments joined together solely by the fusible material;
d) the fusible material having a melting temperature less than a melting temperature of the opposite segments.

19. The fire sprinkler valve in accordance with claim 17, wherein the trigger is an enclosed metal capsule.

20. The fire sprinkler valve in accordance with claim 17, wherein the trigger is an open tube with opposite open ends.
